(19) United States
(12) Patent Application Publication
(10) Pub. No.: US 2012/0009951 A1
(43) Pub. Date: Jan. 12, 2012

(54) Portable flight tracker for use in airplane mode

(76) Inventor: Terrell Alan Poland, Lockhart, TX (US)

(21) Appl. No.: 12/930,469

(22) Filed: Jan. 8, 2011

Related U.S. Application Data
(60) Provisional application No. 61/363,559, filed on Jul. 12, 2010.

(51) Int. Cl. H04W 24/00

(52) U.S. Cl. 455/457

(57) ABSTRACT

A portable electronic device containing an embedded application provides real-time flight status information to users traveling on an airplane while the device is operating in airplane mode with no wireless connectivity. Before departure, the application downloads flight plan route information, digital map data, and other information of interest to the user.

The airplane's in-flight entertainment system repeatedly announces the airplane's latest position on an audio channel. Users can enter position coordinates into the application manually or plug an audio cable into both the armrest of his chair and the application's smart-phone, tablet, net-book or laptop computer.

The application recognizes position information from the user or the announcements and then correlates the airplane's in-flight position to saved map coordinates and displays a moving map image based on the flight's progress. The image includes flight status and links to saved information such as images of points of interest.

### CROSS REFERENCE TO RELATED APPLICATION

This application claims the benefit of U.S. Provisional Patent Application No. 61/363,559 filed on Jul. 12, 2010 which is hereby incorporated by reference herein in its entirety.

### BACKGROUND OF THE INVENTION

1. Background

Many online web sites provide flight status information to users via the Internet. The user must have online access to the web to obtain this information. However passengers on board an airplane cannot use wireless communications from computers or cell phones while the airplane is in flight. If the flight is delayed while in flight due to weather, the passenger must wait for the plane to land before he can make alternative plans.

Some airplanes are equipped with displays that show images of maps with the current location of the airplane superimposed on the map. This provides all passengers with the same flight status information. Passengers do not have the ability to request details on points of interest to them such as images of locations en-route.

There is a need to provide more information to the flying traveler as the flight proceeds. If the information is regularly updated to correspond with the position of the aircraft, the traveler is more engaged and considers the display to be more reliable.

2. Advantages

The present invention enables airplane passengers having portable electronic devices such as mobile phones to track airplane flight positional status in real time while the portable device is in airplane mode without radio frequency connectivity.

### SUMMARY OF THE INVENTION

A means for capturing and saving flight en-route information before the airplane departs then merging it with in-flight positional status updates sent from the airplane entertainment system such that travelers can receive and interact with the displayed graphical information on their personal electronic device based on the changing location of the airplane throughout the flight even when all of the radio and position sensing circuits are disabled in the portable electronic device.

### BRIEF DESCRIPTION OF THE DRAWINGS

Features and advantages of the present invention will become apparent to those skilled in the art from the following description with reference to the drawings, in which:

FIG. 1 shows the resources available to the portable electronic device while it is offline in airplane mode and illustrates how the airplane entertainment system provides real-time flight status updates.

FIG. 2 shows information resources available to the portable electronic device while it is online to the Internet via wireless communications either prior to departure or after landing.

FIG. 3 shows the components inside the portable electronic device that enable it to perform the functions described in this invention.

FIG. 4 shows the connections on the audio cable that distributes the audio inputs and entertainment outputs between the passenger's chair, portable electronic device and personal headset.

### DETAILED DESCRIPTION—FIRST EMBODIMENT

The present invention incorporates information acquisition means and user interaction means to enhance the flying travelers' experience.

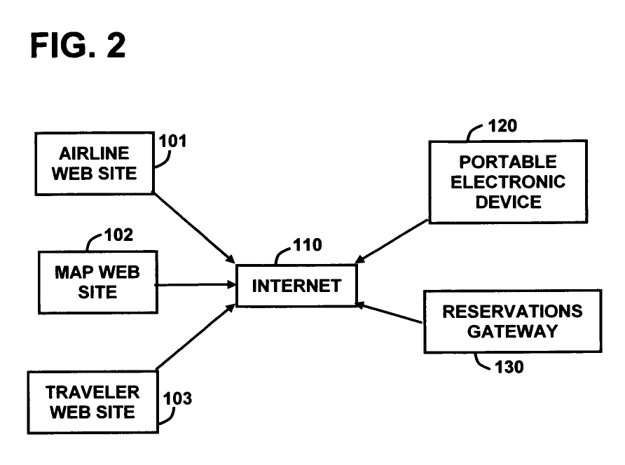

In the preferred embodiment users download an application which runs on a device such as cell phone with a touch sensitive display screen. FIG. 2 shows the resources available to the portable electronic device 120 while it has online wireless communications access to the Internet 110 either before the airplane departs or after it lands. The device's application interacts with online gateways 130 that confirm reservations for flights, hotels and cars. The device's application accesses the web sites for the airlines 101 with which the passenger has booked a flight so that it can download all of the available flight route information. It accesses a map web site 102 that provides map images with latitude and longitude coordinates for the passenger's flight route. It accesses traveler web sites 103 to gather images and information on points of interest near the flight route.

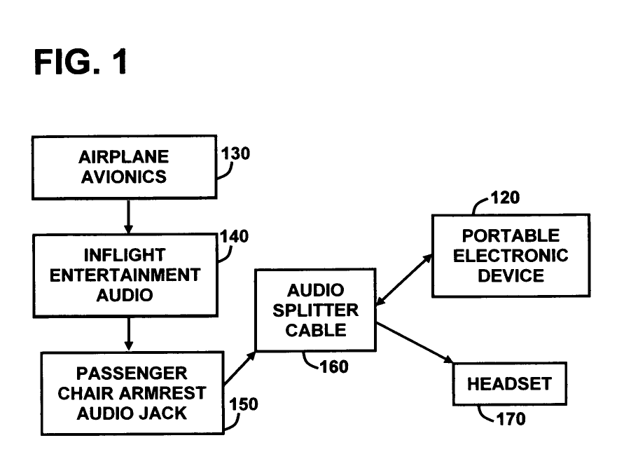

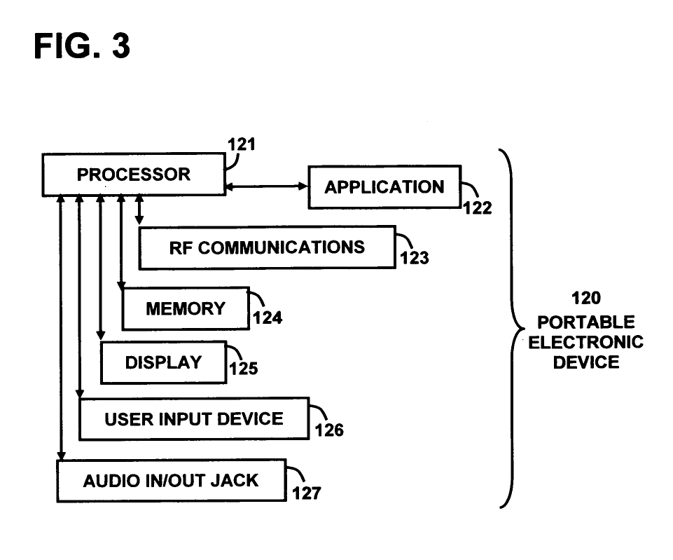

FIG. 1 shows the resources that the portable electronic device 120 uses to update its display information as the flight progresses. In the preferred embodiment, the passenger plugs an audio splitter cable 160 into the jack located in the armrest of his chair 150. To provide the latest airplane position to the application he selects a channel on the airplane's entertainment system 140 which contains a continuously updated stream of latitude and longitude coordinates obtained automatically from the airplane's avionics instruments 130. The portable electronic device provides audio entertainment to the passenger's headset 170. While he has the airplane's position channel selected, the portable electronic device provides the audio from applications running on the device's processor 121 in FIG. 3. When the passenger switches the channel on the chair armrest 150 to one other than the position announcements, the portable electronic device 120 captures the audio from the in-flight entertainment audio system 140 and plays it back over the user's headset 170. The application also displays an alert that the in-flight map image is now being updated based on the estimated flight position rather than the actual position.

In FIG. 3, the processor 121 contained in the portable electronic device 120 executes a computer application 122 which uses a Radio Frequency Communications module 123 to communicate with the Internet when it is online to download the passenger's flight and related data into the device's memory 124 prior to departure. While offline, application 122 uses the cached copy of the flight and map data to continuously update the image on the device's display 125. Application 122 uses the audio airplane position stream provided by the in-flight entertainment audio system 140 in FIG. 1 to adjust its current location information. This includes voice decoding software that converts spoken numeric coordinates to digital coordinates. While in-flight, the user can interact with the display using a user input device 126. In the preferred embodiment he touches the screen. On a computer such as a laptop or netbook, he uses the keypad or touchpad. Such input instructs the application to display previously downloaded expanded information and images from its memory 124 for points of interest en-route or at a connecting or destination city. If the flight is going to arrive late, the passenger can use input device 126 to instruct application 122 to prepare an alternative itinerary in memory 124 to be sent to the reservations gateway 130 in FIG. 2 when the plane lands and online communications are restored. For portable devices having only one jack for both external microphone input and headset output, audio in/out jack 127 provides the means to distribute audio from the airplane or the portable device to the user.

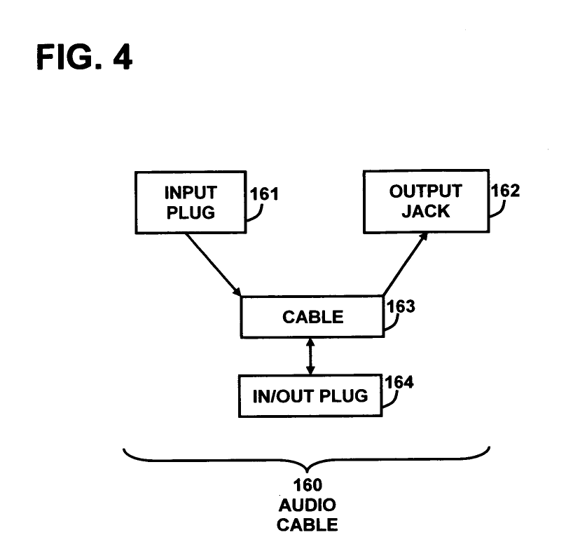

In FIG. 4, a splitter cable 160 provides one male input plug 161 for insertion into the passenger's chair armrest jack 150 in FIG. 1, one female jack 162 for insertion of the personal headset plug 170 in FIG. 1 and one in/out plug 164 for insertion into portable electronic device 120 in FIG. 1, said plugs and jack being attached to cable 163.

### DETAILED DESCRIPTION—ADDITIONAL EMBODIMENT 1

In an alternative embodiment the Application 122 in FIG. 3 uses other techniques to decode the audio airplane position stream provided by the in-flight entertainment audio system 140 in FIG. 1 to adjust its current location information. Instead of using voice decoding software that converts spoken numeric coordinates to digital coordinates, the position data is decoded from a modulated burst of digitally encoded data. This is similar to the operation of an acoustically-coupled analog modem. Digital data could be pulse-width modulated onto a carrier frequency or encoded using other modulation techniques. By encoding the data in a short burst, the in-flight entertainment audio system 140 can mix the position information into other entertainment channels. An example would be in a music channel containing the burst of encoded positional data between songs.

### DETAILED DESCRIPTION—ADDITIONAL EMBODIMENT 2

In another alternative embodiment the electronic audio cable is simplified so the cable 163 connects the input plug 161 to the output jack 162 in FIG. 3 and the application 122 in FIG. 3 uses Interactive Voice Response techniques to decode the audio airplane position stream provided by the in-flight entertainment system 140 in FIG. 1. Before the flight departs and while the portable electronic device has its Global Positioning System circuit still activated, the passenger plugs the electronic cable into the connector in his seat and into the portable electronic device. The application acquires the aircraft's position on the ground and correlates it to the signals being transmitted by the entertainment system. This comprises a training mode during which the application scans the transmissions on the cable to detect how the digital coordinates are encoded. The encoding could be dual-tone multi-frequency signaling, spoken numbers having precise and uniquely differing durations or some other means. This training interval allows the application to adapt to different techniques used by various entertainment systems. The user removes the cable to the portable electronic device and inserts the cable to the headset whenever he wants to listen to the audio channels. He removes the cable to the headset and inserts the cable to the portable electronic device whenever he wants the application to update the aircraft's current position. This embodiment reduces the cost of the cable and allows the application to support a greater variety of entertainment systems.

### CONCLUSIONS, RAMIFICATIONS AND SCOPE

The present invention enables passengers on board an in-flight airplane to remain continuously updated as to the plane's position. When coupled with a mobile phone display application, the passengers' experience is enhanced by maps and related information about the services and amenities available on the ground near the plane's current position.

While disclosed and described with respect to portable electronic devices in general, and cell phones in particular, the present invention has applicability to many other portable electronic devices such as laptop computers and tablets.

What is claimed is:

1. An electronic display system comprising:
a. an aircraft in-flight entertainment system having:
1. means of sending audio signals to passengers on a multiplicity of channels;
2. means of determining airplane position while in flight;
3. means of embedding said position information into at least one audio channel;
b. a portable electronic device having:
1. operational means to disable its wireless communications and position sensing circuitry such that said portable electronic device is in a mode that is for airplane use;
2. memory containing a multiplicity of display information stored prior to the departure of the airplane;
3. a graphical display;
4. means for accepting external input;
5. an application that interprets said position information and accesses said stored information to determine how to update said graphical display;
whereby said application delivers in-flight travel information based on the changing position of the airplane's flight travel even though said portable electronic device is operating in airplane mode.

2. The system of claim 1 wherein:
a. the airplane position information is transmitted as human-recognizable speech that announces the numeric position coordinates of the airplane's changing position;
b. said external input to said portable electronic device is comprised of users listening to said coordinate announcements and entering said position information into said portable electronic device such that said graphical display is updated when the user provides said input.

3. The system of claim 1 wherein:
a. said external input is comprised of an electronic cable that connects said entertainment system to said portable electronic device;
b. said electronic cable relays signals of numeric position coordinates of the airplane's changing position transmitted in said audio channel;
c. said application monitors and captures the position information encoded in said signals relayed by said cable and updates said graphical display when the airplane's position changes;
whereby the graphical display is updated automatically to correspond with the aircraft's actual position.
